(19) United States
(12) Patent Application Publication
(10) Pub. No.: US 2017/0024768 A1
(43) Pub. Date: Jan. 26, 2017

(54) PROVIDING CONTENT BASED ON IMAGE HISTORY

(71) Applicant: Google Inc., Mountain View, CA (US)

(72) Inventor: Wai Kei So, Daly City, CA (US)

(73) Assignee: Google Inc., Mountain View, CA (US)

(21) Appl. No.: 14/152,414

(22) Filed: Jan. 10, 2014

(51) Int. Cl. G06Q 30/02

(52) U.S. Cl. CPC G06Q 30/0263

(57) ABSTRACT

Methods, systems, and apparatus, including computer programs encoded on a computer storage medium, for providing content based on image history. In one aspect, a method includes receiving a request for a content item from a computing device, the request including an identifier identifying the computing device; accessing object data specifying a particular object and a number of occurrences of the particular object in images that were provided, over a specified period of time, to one or more computing devices identified by the identifier; selecting, based on the number of occurrences of the particular object, a first content item that corresponds to the particular object; and providing, in response to the request, the first content item to the computing device.

### BACKGROUND

This specification relates to content distribution.

The Internet has enabled access to a wide variety of resources, e.g., video and/or audio files, web pages for particular subjects, news articles, etc. Access to these resources has likewise enabled opportunities to provide additional content with the resources. For example, a computing device may request a resource, such as a news web page from a news publisher, by submitting a resource request to the publisher. The resource can include instructions that cause the computing device to request content items for presentation with the resource. Content items that may be of interest to a user can be identified by a content item management system in response to the request, for example, based on information included in the request.

### SUMMARY

In general, one innovative aspect of the subject matter described in this specification can be embodied in methods that include the actions of receiving a request for a content item from a computing device, the request including an identifier identifying the computing device; accessing object data specifying a particular object and a number of occurrences of the particular object in images that were provided, over a specified period of time, to one or more computing devices identified by the identifier; selecting, based on the number of occurrences of the particular object, a first content item that corresponds to the particular object; and providing, in response to the request, the first content item to the computing device. Other embodiments of this aspect include corresponding systems, apparatus, and computer programs, configured to perform the actions of the methods, e.g., encoded on computer storage devices.

These and other embodiments can each optionally include one or more of the following features. The operations may further comprise determining that the number of occurrences of the particular object meets a threshold number of occurrences, and selecting the first content item may comprise selecting the first content item in response to determining that the number of occurrences of the particular object meets the threshold number of occurrences.

Obtaining object data may comprise: obtaining, based on the identifier, an image history specifying, for the one or more computing devices identified by the identifier, a set of images that were previously provided to the one or more computing devices; identifying, for at least one image in the set of images, one or more objects depicted in the image; and generating object data specifying, for each identified object, a number of the images in which the object was identified.

The operations may further comprise: determining a first bid value for the first content item based on the number of occurrences of the particular object to which the first content item corresponds; providing the first bid value for the first content item to a content item selection process that, based at least in part on bid values, selects one or more content items to be provided in response to the request; and receiving an indication that the first content item is selected by the content item selection process.

The operations may further comprise identifying, for the particular object, a profitability value that indicates a measure of profitability of the particular object, and wherein the first bid value for the first content item is based on the profitability value.

The object data may specify second object and a second number of occurrences of the second object in images that were provided, over the specified period of time, to the one or more computing devices identified by the identifier, and the method may further comprise: selecting, based on the object data, a second content item that corresponds to the second object; determining a second bid value for the second content item based on the second number of occurrences of the second object to which the second content item corresponds; and providing the second bid value for the second content item to the content item selection process.

Each image that was previously provided to the one or more computing devices may have been provided to the one or more computing devices by a publisher of network resources.

Each image in the set of images that were previously provided to the one or more computing devices may be associated with a timestamp that corresponds to a time that the image was provided to the one or more computing devices, and each timestamp of each image in the set of images may be within a threshold period of time from a current time.

Identifying, for each image in the set of images, one or more objects depicted in the image may comprise identifying a most prominent object depicted in the image.

Particular embodiments of the subject matter described in this specification can be implemented so as to realize none, one, or more of the following advantages. An interest in objects depicted in images may be inferred based on occurrences of the objects in images provided to a computing device. Content item providers may select content items that may be of interest to users of computing devices based on the objects depicted in images provided to the computing devices. Additional selection criteria for content item providers may be beneficial for content item providers who wish to be selective with a content item budget, or who have a particular interest in providing content items to users who have viewed particular objects. Providing content items likely to be of interest to users of computing devices may, in turn, lead to satisfaction of users' informational needs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content items are provided based on image history.

FIG. 2 is a block diagram of an example data flow for requesting and receiving images and content items.

FIG. 3 is a flow diagram of an example process in which content items are provided based on image history.

FIG. 4 is a block diagram of an example data processing apparatus.

Like reference numbers and designations in the various drawings indicate like elements.

### DETAILED DESCRIPTION

A content item management system facilitates the distribution of content items to a computing device based on images that have been presented on the computing device. For example, the content item management system may obtain a number of occurrences of particular objects appearing in images that were recently presented on the computing device. When the computing device requests a content item, such as an advertisement, from the content item management system, the content item management system can provide a content item that is related to an object that frequently appeared in the images that were recently presented on the computing device.

For example, a computing device, such as a personal computer or cellular phone, may periodically request web pages and other network resources from various publishers across a network, such as the Internet. The network resources provided to the computing device may include images, e.g., images included in news articles, social media pages, blog posts, and entertainment websites. A record of each image provided to the computing device is stored in image history for the computing device. The image history may be stored on the computing device, or stored on a server device accessible to the computing device.

An image management system obtains the image history, e.g., from the computing device or from a server storage device, and generates object data for the computing device. Object data is generated for a computing device by identifying objects in the images included in the image history for the computing device. For each object identified, the object data indicates a number of occurrences of that object in images that are included in the image history. For example, object data may specify that a particular handbag appears in five images in the computing device's image history.

When the computing device requests a content item, such as an advertisement, from the content item management system, the content item management system can obtain the object data and use it to provide an advertisement based on the object data. Using the handbag as an example, it may be inferred that an advertisement that includes, or is related to, the particular handbag may be of interest to a user of the computing device based on the fact that the handbag has been depicted in several of the images presented at the user device. The content item management system may, based on the object data, select the advertisement that includes the handbag, or is related to the handbag, and provide it to the computing device in response to the content item request.

In some implementations, the number of occurrences of an object in the object data may be used to formulate a bid for a corresponding content item, which may then be provided to a content item selection process, such as an auction, to determine which content item(s) to provide to the computing device. In some implementations, a bid for a content item may be adjusted based on the number of occurrences of an object that corresponds to the content item, e.g., each bid for a content item that corresponds to an object included in the object data may be adjusted using an adjustment value (e.g., a multiplier) that is based on the number of occurrences of the object. In some implementations, multiple content items may be chosen and provided to the content item selection process based on the object data, e.g., when multiple objects in the object data correspond to different content items, some or all of the different content items may each be selected and provided to the content item selection process with its own bid.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content item management system that may be more relevant to the user. Similarly, users may be provided with an opportunity to control whether programs or features collect image history, e.g., by providing users with an option to opt-out of image history collection. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content item management system.

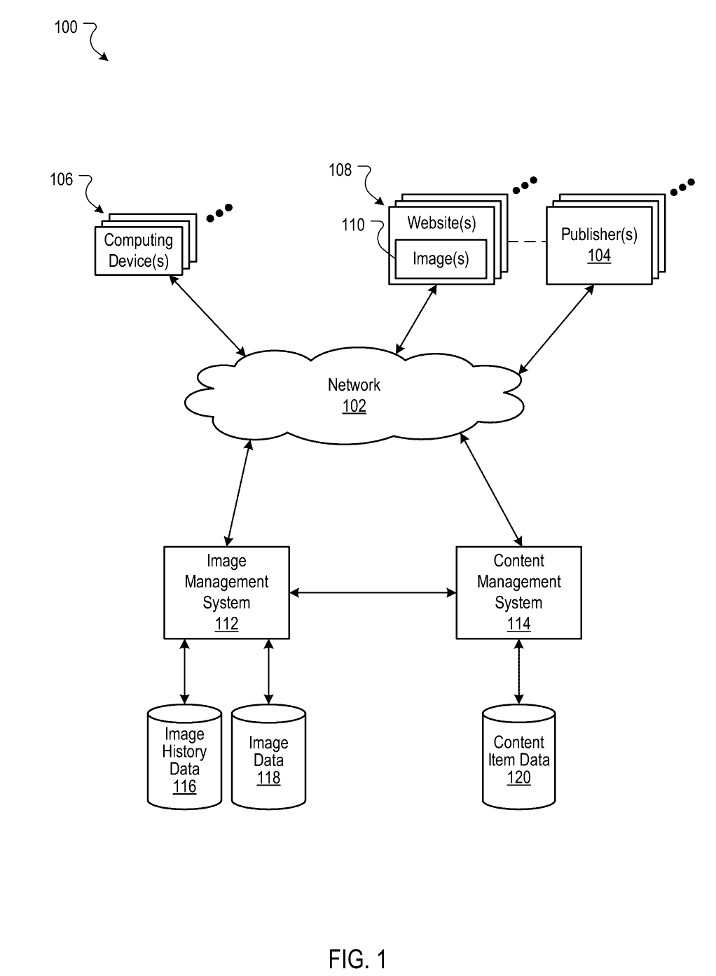

FIG. 1 is a block diagram of an example environment 100 in which content items are provided based on image history. A computer network 102, such as a local area network (LAN), wide area network (WAN), the Internet, or a combination thereof, connects publishers 104, computing devices 106, publisher websites 108, an image management system 112, and a content item management system 114. The online environment 100 may include any number of publishers 104, computing devices 106, and websites 108.

A website 108 includes one or more resources that include content, such as images 110, and are associated with a domain name and hosted by one or more servers. An example website 108 is a collection of web pages formatted in hypertext markup language (HTML) that can contain text, images 110, multimedia content, and programming elements, such as scripts. Each website 108 is maintained by a content publisher 104, which is an entity that controls, manages and/or owns the website 108.

A resource is data that can be provided by the publisher 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as scripts).

A computing device 106 is an electronic device capable of requesting and receiving resources over the network 102. Example computing devices 106 include personal computers, mobile communication devices, and other devices that can send and receive data over the network 102. A computing device 106 typically includes a user application, such as a web browser, to facilitate the sending and receiving of data over the network 102. The web browser can enable a user to display and interact with text, images, videos, music and other information typically located on a web page at a website.

The computing devices 106 submit requests for resources of a particular website from the publisher of that website. The request may include an identifier that uniquely identifies the computing device, user, and or/account that submits the request. The unique identifier can be data from a cookie stored at the computing device, or a user account identifier if the user maintains an account with the publisher, or some other identifier that identifies the computing device, user account, and/or the user using the computing device. Identifiers may, in some implementations, be associated with multiple computing devices, multiple users, and/or multiple accounts. While some of the examples described below specify object data for a single computing device, the object data may correspond to multiple computing devices, e.g., when multiple computing devices are associated with the same identifier, the object data can be the same for each of the computing devices.

The publisher of the website 108 receives the request for the resource from the computing device 106 and provides the resource to the requesting computing device 106. The requesting computing device 106 may then render the resource for display to a user.

The image management system 112 manages various tasks related to image resources. For example, the image management system 112 may manage image histories for computing devices 106 in an image history data 116 data store. A computing device's image history may specify image resources that were provided to the computing device. The image history may be provided, for example, by the computing device, e.g., through software on the computing device that reports image history to the image management system 112, or by website publishers 104 who report an identifier of a computing device that requested an image from a publisher's website.

The image management system 112 may also perform image analysis processes, such as object recognition. For example, the image management system may use one or more object recognition processes, e.g., edge detection, blob detection, gradient matching, and various feature detection processes to determine objects depicted in images. The image data 118 may include data to facilitate object recognition, such as a database of objects that can be compared to objects detected in images. The object recognition process(es) performed by the image management system 112 enable the image management system 112 to identify objects included in the images identified in a computing device's image history. The objects can be stored for a computing device as object data either with, or separately from, the computing device's image history.

The content item management system 114 facilitates distribution of content items based on selection rules corresponding to the content items. For example, the content item management system 114 allows publishers to specify selection rules that can condition distribution of a content item based on a context of a content item request that is received from the computing devices 106. Example selection rules include keyword rules, in which content providers specify keywords that are used to control selection of their content items, and bids for the specified keywords. The keywords can be, for example, terms that are present in a computing device's object data, search queries sent to a search engine, or derived from webpage content. The bids can be used to select content items that will be provided to the computing devices 106. For example, content items that are associated with keywords matched by information included in a content item request can be selected to participate in an auction (or another selection process) using the bids corresponding to the keywords. In turn, at least some of the content items are selected for presentation in content item slots of resources. Content items can be provided for many different resources, such as a search results page resource, or one of the resources included in a publisher websites 108.

Content items may be provided in various forms. In some examples, content items may include graphical advertisements, such as banner ads, text, images, audio, video, or a combination of one of more of any of such components. Content items may include embedded information, such as embedded media, links, meta-information, and/or machine executable instructions. A content item impression refers to any form of presentation of a content item to a user. In some examples, a content item impression may occur when a content item is displayed on a computing device.

A content item slot is a portion of a resource that is populated with a requested content item. The content item slot can be populated, for example, in response to a request for the content item that is initiated by way of the computing device executing code corresponding to the content item slot when the resource is rendered at the computing device. As used throughout this document, a content item is a discrete unit of content that is provided for presentation at a computing device from which a request for the content item originated. Example content items include audio files, video files, advertisements, or other units of content that can be presented with a requested resource.

The content item management system 114 is in communication with a data storage device that stores content item data 120, such as campaign data and performance data for content items. For example, the content item data 120 can specify content items, selection information, and budgeting information for content item providers, as well as performance measurements for content items. The content item data 120 may also include a mapping of objects to content items. As described in further detail below, the content item management system 114 can use object history for a computing device and the mapping of objects to content items to select content items to be provided to computing devices.

Information included in the content item data 120 may be used as input parameters to a content item selection process, such as an auction. For example, in an auction the content items may be ranked according to a score that, in some implementations, is a value determined based on a content item bid and one or more parameters specified in the content item data 120. One or more highest ranked content items resulting from the auction are selected and provided to the requesting computing device.

While the image management system 112 and content item management system 114 are depicted separately, they may be part of the same system, or implemented together in a distributed processing environment. Similarly, the image history data 116, image data 118, and content item data 120 may be stored separately, as depicted, or together, in one or more data storage devices.

As described in further detail below, the content item management system 114 uses the content item data 120 and image history data 116 to facilitate the distribution of content items to computing devices 106.

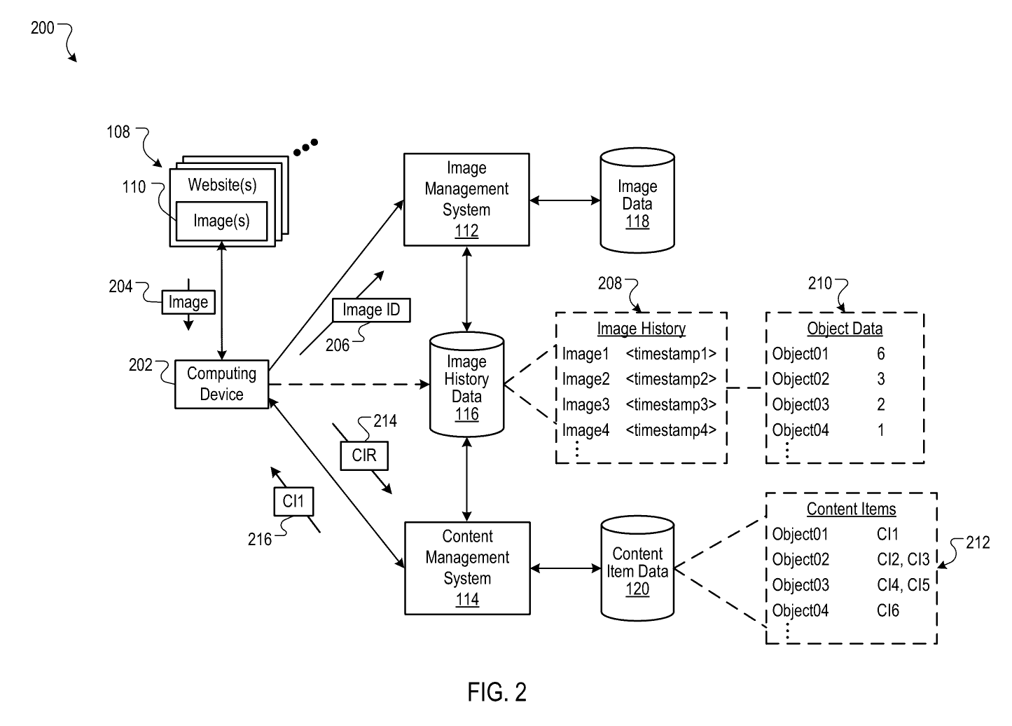

FIG. 2 is a block diagram of an example data flow 200 for requesting and receiving images and content items. In the data flow 200, a computing device 202 requests and receives images 110 and other resources located at publisher websites 108. For example, the computing device 202 may use a web browser to facilitate requesting, receiving, and rendering images included in news articles, blog posts, social media content, search engine results, and other content that is published on the Internet and/or a local network.

In some implementations, each image provided to the computing device 202, such as image 204, has an image identifier. The image identifier is data used to identify an image, such as an address (e.g., URL) of the image. For example, an image identifier for the image 204 in the example data flow 200 may be “http://www.example.com/images/image01.jpg,” which is an address that may uniquely identify and specify the location of the image.

The computing device 202 may, in some implementations, provide image identifiers, such as Image ID 206, to the image management system 112. The image management system 112 may, in turn, store a record of the image being provided to the computing device 202 in image history 208 for the computing device 202, e.g., in the image history data 118. Image identifiers may be provided periodically, e.g., in batches, or in response to an image being requested, received, and/or rendered on the computing device 202. For example, the web browser of the computing device 202 may provide an image identifier to the image management system 112 in response to determining that a corresponding image is rendered in a viewing area of the web browser on the computing device 202.

As discussed above, the image history 208 specifies the images that were provided to the computing device 202. The image history 208 may also include other information, such as a timestamp that indicates, for each image, a time that the image was provided to the computing device 202. In some implementations, the records included in the image history 208 expire, or are removed from the image history 208, after a certain period of time. For example, the image management system 112 may specify a threshold period of time, such as one month, and any images that were last provided to the computing device 202 more than one month prior to a current system time may be removed from the image history 208. Other limitations may also be placed on the image history 208, such as only keeping a record of images larger than a certain size, e.g., in pixels, only keeping a certain number of images from a particular domain, not allowing duplicate images, or only including images that depict an object.

The image management system 112 uses the image history 208 to generate object data 210 for the computing device 202. The object data 210 specifies one or more objects and, for each object, a number of occurrences of the object in images that were provided to the computing device 202. For example, if 50 images included in the image history 208 depict a car, the object data 210 will specify that a car occurred 50 times in the images included in the image history 208.

In some implementations, multiple objects may be detected in an image. For example, an image that depicts a car may also depict a person holding a handbag. In these situations, the image management system 112 may detect three objects in a single image: the car, the person, and the handbag. This may result in three separate occurrences being recorded in the object data. In some implementations, certain objects, e.g., those specified by an administrator of the image management system, may be ignored. For example, occurrences of commonly occurring objects, such as people, trees, clouds, etc., may not be recorded in object data.

In some implementations, only one occurrence of a particular object may be recorded for a given image. For example, if an image depicts five cars and two handbags, the image management system 112 may only record a single occurrence of a car and a single occurrence of a handbag in the object data. In some implementations, multiple occurrences of a particular object in an image may be recorded as multiple occurrences. Using the same example above, e.g., five cars and two handbags, the image management system may record five occurrences of a car and two occurrences of a handbag in the object data.

In some implementations, only the most prominent object depicted in an image is recorded in the object data for that image. Prominence may be measured by many methods or combinations of methods. For example, prominence of an object, relative to other objects depicted in an image, may be measured by the surface area occupied by the object in an image, by how close the object is to the center of the image, how much of the object is depicted in an image, etc. By way of example, the image management system 112 may determine that a car is the most prominent object in an image that depicts a car that both occupies more surface area of the image than a handbag included in the image, and is more centered than the handbag.

In some implementations, the image management system 112 may record occurrences of “objects” that are non-tangible things, or things that may not fit a typical definition of an object. For example, images can depict events, such as a football game or barbeque; particular people, such as well-known celebrities or politicians; and more conceptual ideas, such as the winter season or music. These objects may be detected in a manner similar to those of other tangible or traditional objects, which is discussed in further detail below.

In some implementations, an object depicted in an image may be identified as more than one type of object, or as different variations of the same object. For example, a car depicted in an image may be identified as an “automobile,” a “car,” a “luxury car,” a “sports car,” and/or a “Brand X Model Y car.” In these situations, the image management system 112 may record an occurrence of one, some, or all of the possible objects in the object data 210. In some implementations, the object data 210 may be organized into a hierarchy of objects. Object occurrences may be organized in a hierarchy, for example, based on the granularity of objects. By way of example, the object data 210 may indicate that 10 automobiles appeared in images provided to the computing device 202, that six of those automobiles were cars while four were trucks, that five of the cars were luxury vehicles while one was a sports car, and that four of the five luxury cars were Brand X Model Y while one was Brand A Model B.

The actual object recognition process(es) used by the image management system 112 to identify objects depicted in images may vary. In some implementations, the image data 116 includes data that associates reference images and/or reference image features with different labels and/or objects. The image management system 112 can retrieve images in a computing device's image history, e.g., using the image identifier of the image, and compare those “historical” images, portions of the images, and/or features of those images to the reference images and features in the image data 118 to identify objects depicted in the historical images. A comparison between images, portions of images, and/or image features may be used by the image management system 112 to determine a measure of similarity between images.

A variety of appropriate image comparison algorithms can be used to make a determination of similarity between images. For example, color, contrast, point, text, and/or edge detection processes may be used to identify visual features of a reference image included in the image data 118, and the data obtained from these processes can be compared with a sub-portion of a historical image included in the image history 206 to determine a measure of similarity between the visual features of the reference image and the historical image.

Using an example historical image of a car and a handbag, the image management system 112 may use edge detection and/or other feature detection techniques to determine that the portion of the historical image depicting the handbag includes features that make the sub-portion a candidate for comparison to reference images included in the image data 118. The sub-portion of the image including the handbag, and the corresponding features, can be compared to the image data 118 to identify an image with similar features, such as a reference image that depicts the same handbag. The reference image of the handbag may be associated with one or more labels or object names in the image data 118, such as a “handbag” object label or “Brand ABC Handbag” label. Assuming a match between images, the image management system may record an occurrence of the object/label in the object data 208.

In some implementations, optical character recognition may be used to identify text depicted in images, which can be used to identify the image. For example, if a car depicted in an image includes decals specifying a brand name and model, optical character recognition processes may be able to identify the text in the decals and provide an indication that the image depicts a car that corresponds to that brand name and model.

Other image feature detection and object recognition processes, and combinations thereof, may be used to determine similarities between images in image history and reference images included in image data to determine depicted objects. Other example techniques include interest point detection, scale-invariant feature transform, pixel matching, and other appropriate image processing techniques. In some implementations, a match or similarity may be determined, for example, when a predetermined number or percentage of compared features are within a threshold measure of similarity to one another. In addition, a measure of similarity may be binary—e.g., similar or not similar—or may be represented by a score, such as a similarity score between 0 and 1, where 0 indicates no similarity, and 1 indicates an identical image. In some implementations where a similarity score is used, an occurrence of an object may only be recorded if a similarity score between a sub-portion of a historical image and a reference image meets a threshold measure of similarity.

In some implementations, some or all of the image history recording and object recognition processes performed by the image management system 112 may be performed by a computing device. For example, a computing device may keep track of its own image history by recording requests or receipts of images in an image history data storage device, as opposed to providing data to the image management system 112 for recording in image history data 116.

While the image history 206 and object data 208 are depicted separately in the example data flow 200, other representations of the data may be used. For example, the objects detected in an image may be included in the corresponding image's record in the image history. In this implementation, a record in the image history 206 may specify, for example, “Image1, timestamp1, object01, object02, object03,” which indicates that Image1, which was provided to the user device at the time specified by timestamp1, depicts three objects: object01, object02, and object03.

As described above, the content item management system 114 maintains content item data 120, which can include, as in the example data flow 200, a mapping of objects to content items 212. The mapping of objects to content items may be created by a variety of methods, or combinations of methods.

In some implementations, content item providers, such as advertisers, can specify objects and associate content items with the objects. For example, the content item management system 114 can provide an interface to an advertiser, who can specify which objects are of interest to the advertiser and, for each object which advertisement or set of advertisements should be presented. In some implementations, a content item provider may associate an object with an adjustment value, such as a multiplier, which can be used to increase or decrease a bid associated with a content item that is eligible to be submitted to a content item selection process, such as an auction.

By way of example, an advertiser, such as a luxury automobile company, may want to provide advertisements for a product, such as the company's Brand X automobiles. The advertiser may be interested in providing advertisements to computing devices that have recently and/or frequently viewed luxury vehicles. The advertiser, using the content item management system interface, may specify a “luxury vehicle” object and one or more advertisements to present to computing devices that have frequently been provided images that depict luxury vehicles. In some implementations, an advertisement that corresponds to an object may also be associated with a bid adjustment value that can be used to increase, or in some implementations decrease, a bid for the advertisement when the advertisement is selected to compete in a content item selection process based on object data for a computing device that requested an advertisement. For example, a multiplier may be applied to all bids for content items that are selected based on the content items' association with one or more objects included in the object history of a computing device that requested a content item. As another example, a content item provider may specify a separate specific increase or decrease in bid value for each of the content item provider's content items. The specific increase or decrease may be applied when one of the content item provider's content items is selected to compete in the content item selection process based on its association with an object that is included in the object data of a computing device that requested a content item.

In some implementations, the content item management system 114 provides an indication to the image management system 112 that specifies which objects are of interest to content item providers. The image management system 112 may use this information to selectively determine which objects to detect in images included in image history. For example, the image management system 112 may be capable of matching many objects, but if no content item providers are interested in providing content items based on images depicting plastic cups, the image management system will not attempt to detect plastic cups in images included in image history. In some implementations, the image management system 112 may only detect, and record in object data, objects in which a content item provider has indicated an interest.

In some implementations, the content item management system 114 may include objects in the content item data 120 based on the objects' inclusion in object data 210. For example, the content item management system 114 may populate a list of objects based on objects identified in the image history data 116. The list of objects may, in some implementations, be made available to content item providers, and the content item providers can choose which object(s) to associate with which content item(s) of the content item providers. In some implementations, the content item management system 114 may associate content items with objects. For example, if the a content item included in the content item data 120 is associated with a keyword, such as “luxury car,” the content item management system 114 may associate that content item with the “luxury car” object in a mapping of objects to content items.

The mapping of objects to content items 212 may be used by the content item management system 114 to provide content items in response to content item requests. As depicted in the example data flow 200, the content item management system 114 may receive a content item request 214 from a computing device 202. The content item request 214 includes an identifier that identifies the computing device 202.

Using the identifier, the content item management system 114 can obtain object data 210 for the computing device 202. The example object data 210 specifies that a particular object, Object01, occurred six times in images that were provided to the computing device 202. As described above, the object data 210 can be obtained based on image history 208, which specifies images that were previously provided to the computing device 202, e.g., Image1, Image2, Image3, and Image 4.

In this example, based on being associated with six occurrences, the content item management system 114 selects the content item, CI1, that is associated with Object01 in the mapping of objects to content items 212. In some implementations, the object selected, e.g., Object01, may be the object with the most occurrences. In some implementations the content item management system selects the object with the most occurrences within a certain threshold period of time, e.g., an object with the most occurrences within the past hour. Other information may be used to determine which object to select, e.g., only selecting objects that have corresponding content items in the content item data 120, and/or not selecting an object that was recently selected by the content item management system 114 for the same computing device 202. In some implementations, the number of occurrences of an object must meet a threshold number of occurrences to be eligible for selection. For example, if an occurrence threshold is five, only Object01 in the example data flow 200 would be eligible for selection.

In some implementations, the content item management system 114 determines a bid value for the selected content item, e.g., CI1. The bid may be a particular amount that a content item provider specified for content items that are provided based on image history. In some implementations, a standard bid for a content item may be adjusted by an adjustment value such as a multiplier, when the content item is eligible to be provided based on image history data 116. For example, content item CI1 may have a standard bid of $1.00 for serving in a general context, but may be associated with multiplier of 2, resulting in a bid of $2.00, when CI1 is eligible to be served based on image history data 116, e.g., as shown in the example data flow 200. Many other methods may be used for determining a bid value for a content item, such as using an estimated profitability of the content item, the profitability of a product/service advertised in a content item, and/or based on the need to fulfill a quota of content items for the corresponding content item provider.

In some implementations, the bid for a content item may be based on the number of occurrences of the object, e.g., Object01, to which the content item corresponds. Many methods exist for adjusting or determining a bid based on the number of occurrences. For example, each occurrence could be worth $0.01, and a baseline bid value could be increased by $0.01 for each occurrence. Using a baseline bid of $0.25 and six occurrences of Object01, the bid for CI1 may be $0.31. As another example, a bid multiplier may be 1.XX, where XX is the number of occurrences up to a maximum of 99 occurrences. Using the same example occurrences of Object01, the bid multiplier for CI1 may be 1.06, which can be applied to a standard bid value for CI1.

In some implementations, multiple content items may be selected based on the object data. For example, the object data 210 may specify a second object, e.g., Object02, and the content item management system may select one or more second content items for the additional object(s), e.g., CI2 and/or CI3 for Object02, based on the number of occurrences of Object02 meeting an occurrence threshold. Additional content items selected based on the object data may also be associated with a bid value and/or bid multiplier, which can be provided to the computing device with the first content item or submitted to the content item selection process. For example, a bid for CI1 may have a multiplier of 1.06 and compete in a content item auction with CI2 having a bid multiplier of 1.03 to determine, based at least in part on an original bit value for each content item and the corresponding multipliers, which content item to provide.

In the example data flow 200, content item CI1 216 is selected, and the content item management system 114 provides it to the computing device 202 in response to the content item request 214. The computing system 202 may then cause display of the content item, e.g., using a web browser.

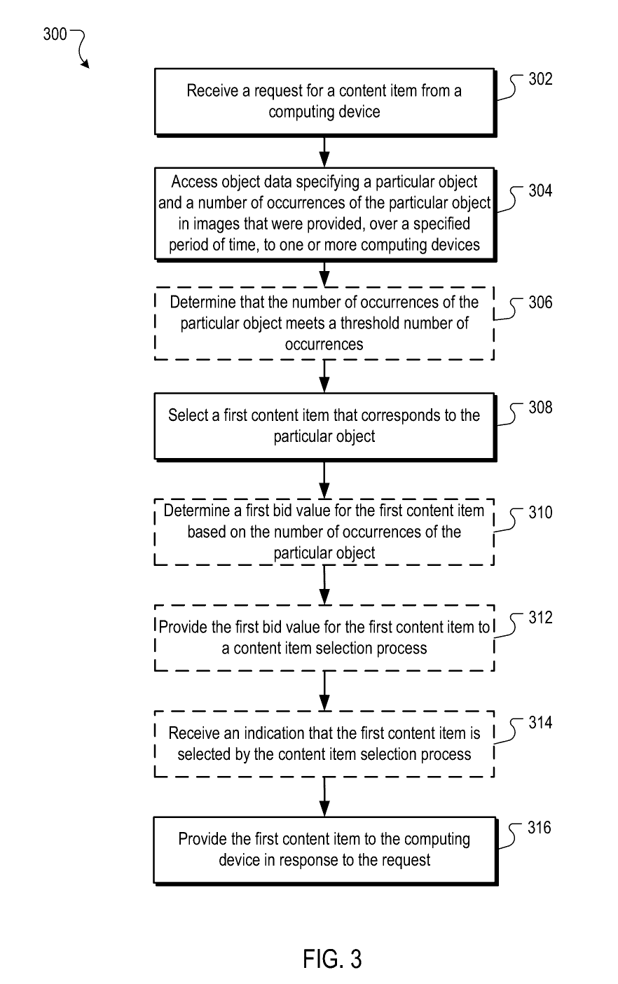

FIG. 3 is a flow diagram of an example process 300 in which content items are provided based on image history. The process 300 may be implemented by data processing apparatus, such as the content item management system 114 of FIG. 1.

A request for a content item is received from a computing device (302). The request may include an identifier identifying the computing device. For example, a personal computer or mobile computing device may request an advertisement from the content item management system for placement in an advertisement slot of a web page.

Object data is accessed that specifies a particular object and a number of occurrences of the particular object in images that were provided, over a specified period of time, to one or more computing devices identified by the identifier (304). In some implementations, obtaining object data includes obtaining, based on the identifier, an image history specifying, for the one or more computing devices, a set of images that were previously provided to the computing devices. For at least one image in the set of images, one or more objects depicted in the image may be identified, e.g., using object recognition processes. Object data may then be generated, the object data specifying, for each identified object, a number of the images in which the object was identified. For example, a personal computer periodically receives images while browsing the Internet, and information related to presentation of these images, such as the web address and a timestamp indicating a time of receipt, can be recorded in an image history for the computer. An image management system may then use object recognition processes on the images included in the image history to identify objects depicted in at least some of the images. Each object depicted in an image can be recorded in object data for the computer along with a number of occurrences of that object in the images included in the image history. While multiple objects may be identified in an image, in some implementations, only a most prominent object depicted in the image is identified and recorded in object data.

In some implementations, each image that was previously provided to the one or more computing devices, e.g., each image included in the image data for an identifier, was provided by a publisher of network resources. A publisher may be, for example, a news website that includes images in its news stories, which are requested by and provided to a computing device. Different images at different websites related to two different topics may depict the same object, e.g., an image of a car may appear on a social media website as well as a news website or encyclopedia website.

In some implementations, each image in the set of images that were previously provided to the one or more computing devices is associated with a timestamp that corresponds to a time that the image was provided to the one or more computing devices. Each timestamp may, in some implementations, be required to be within a threshold period of time from a current time in order for the image to be identified in the image history. For example, an image management system may only keep a record of images for the past month, and records for images with a timestamp more than a month prior to the current time may be discarded from image history data.

In some implementations, a determination is made that the number of occurrences of the particular object meets a threshold number of occurrences (306). For example, a threshold number of occurrences may be 10, and only objects with 10 or more occurrences, e.g., depictions in 10 or more different images included in the image history, may meet the threshold. In some implementations, the process 300 may end if no objects have a number of occurrences that meet the threshold.

A first content item that corresponds to the particular object is selected (308). The selection is based on the number of occurrences of the particular object. In some implementations, the selection may be in response to determining that the number of occurrences of the particular object meets the threshold number of occurrences. Other methods for selecting a content item, e.g., based on the object data, may be used. For example, a content item may be selected for the object with the most occurrences in the object data. As another example a content item may be selected for an object that was most recently identified as being depicted more than a threshold number of times. As described in detail above, the content item may be associated with the object by a content item provider and/or a content item management system, e.g., based on keywords that match the object or administrator preference

In some implementations, a first bid value is determined for the first content item based on the number of occurrences of the particular object (310). For example, a baseline bid for a content item may be incrementally increased by an amount proportional to the number of occurrences of the object to which the content item corresponds, e.g., a bid may be increased by $0.02 per occurrence. As described above, other methods may be used to determine a bid value based on the number of occurrences of a particular object. In some implementations, a profitability value that indicates a measure of profitability corresponding to a sale of the particular object may be identified for the particular object, and the first bid value for the first content item may be based on the profitability value. For example, a multiplier for a bid may be based on a profit margin for an object or for the content item associated with the object, where a more profitable object or content item has a higher bid multiplier than a less profitable object.

In some implementations, the first bid value for the first content item is provided to a content item selection process (312). For example, the bid may be provided to a content item auction that, based at least on bid values, selects one or more content items to be provided in response to a content item request.

In some implementations, the process 300 receives an indication that the first content item is selected by the content item selection process (314). For example, the first content item may have had the highest bid, or highest score that was based on the first bid value, in a content item auction. The bid values may not be the only factor used by a content item selection process to select content items. Other factors, such as quality and/or historical performance of the content item, may also be considered in determining which content item is selected by the content item selection process. For example, a combination of a quality score, performance score, and bid value may be used to determine scores for content items that are eligible for selection by a content item selection process. The content items may be ranked according to their scores and the top content item(s) selected for presentation to a computing device in response to a content item request.

The first content item is provided to the computing device in response to the request (316). For example, the first content item may be an advertisement, and the content item management system may provide the advertisement to the computing device in response to the computing device's request for an advertisement. In implementations where a threshold number of occurrences is used, providing a content item for an object to a computing device may depend on the number of occurrences for the object meeting the threshold number of occurrences.

In some implementations, the process 300 can be used to select multiple content items in response to the content item request, and multiple objects may also be used for purposes of content item selection. For example, the object data may specify a second object and a second number of occurrences of the second object in images that were provided, over a specified period of time, to the one or more computing devices identified by the identifier. The object data may, in some implementations, specify that the second number of occurrences of the second object meets the threshold number of occurrences. In these situations, a second content item that corresponds to the second object may also be selected based on the object data, and a second bid value for the second content item may be determined based on the second number of occurrences of the second object to which the second content item corresponds. The second bid value may then be provided to the content item selection process.

Additional content items that correspond to addition objects may, in some implementations, also be provided to the content item selection process. In some implementations, multiple content items may be associated with an object, and one, some, or all of the content items may be selected. For example, four objects may be associated with a number of occurrences that meets a threshold number of occurrences, and two content items may be selected for each of the four objects, resulting in eight content items being provided to a content item selection process with eight bid values.

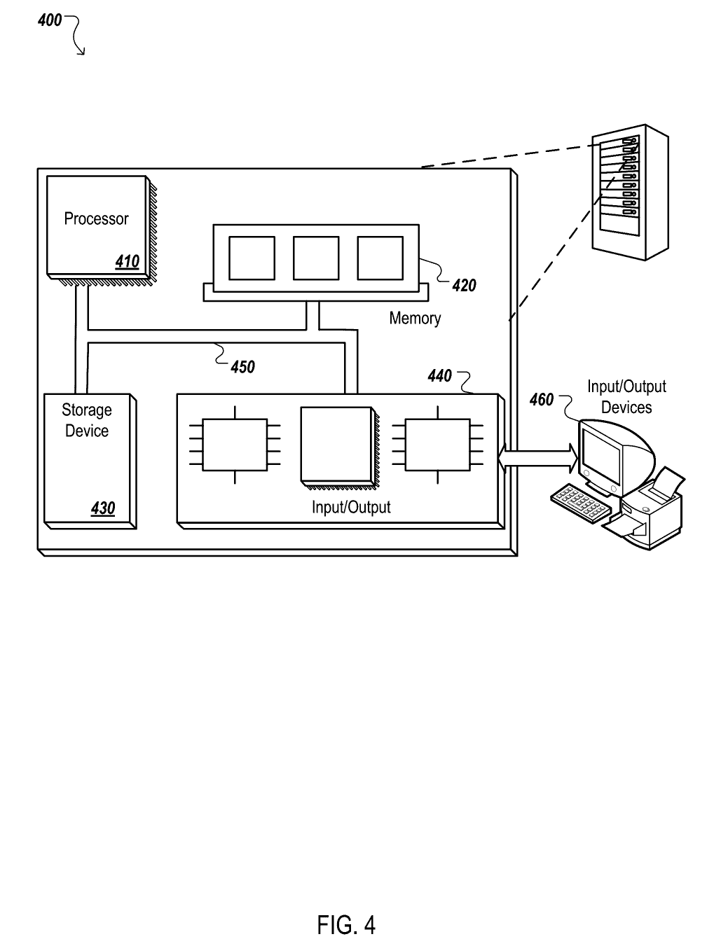

FIG. 4 is a block diagram of an example data processing apparatus 400. The system 400 includes a processor 410, a memory 420, a storage device 430, and an input/output device 440. Each of the components 410, 420, 430, and 440 can, for example, be interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can, for example, include a hard disk device, an optical disk device, or some other large capacity storage device.

The input/output device 440 provides input/output operations for the system 400. In one implementation, the input/output device 440 can include one or more network interface devices, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's computing device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a computing device (e.g., for purposes of displaying data to and receiving user input from a user interacting with the computing device). Data generated at the computing device (e.g., a result of the user interaction) can be received from the computing device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented by one or more data processing apparatus, the method comprising:
receiving, from a computing device associated with a given user and by the one or more data processing apparatus, image identifiers specifying images that were presented at the computing device;
detecting, by the one or more data processing apparatus, objects depicted in the images that were presented at the computing device, including performing one or more object recognition processes on the images;
storing, in an object history data store by the one or more data processing apparatus and based on the detecting, object data including a number of times that a particular object was visually depicted in the images that were presented at the computing device in association with an identifier of the user;
receiving, by the one or more data processing apparatus, a request for a content item from the computing device, the request including the identifier of the user;
accessing, by the one or more data processing apparatus and in the object history data store, the object data specifying the number of times that the particular object was visually depicted in the images that were presented at the computing device;
determining, based on the object data associated with the identifier and by the one or more data processing apparatus, that the particular object was visually depicted in multiple different images at multiple different webpages that were accessed by the computing device over a specified period of time;
determining, by the one or more data processing apparatus, that the number of times that the particular object was visually depicted in the multiple different images at the multiple different webpages meets a threshold number of times;
selecting, based on the determination that the number of times meets the threshold, a first content item that visually depicts the particular object or includes text identifying the particular object for distribution to the computing device, the selecting including using a mapping of objects to content items to determine that the first content item is mapped to the particular object; and
distributing, in response to the request and to the computing device, machine readable instructions that initiate presentation of the first content item with a third party webpage.

2-3. (canceled)

4. The method of claim 1, further comprising:
determining a first bid value for the first content item based on the number of occurrences of the particular object to which the first content item corresponds;
providing the first bid value for the first content item to a content item selection process that, based at least in part on bid values, selects one or more content items to be provided in response to the request; and
receiving an indication that the first content item is selected by the content item selection process.

5. The method of claim 4, further comprising:
identifying, for the particular object, a profitability value that indicates a measure of profitability of the particular object, and wherein the first bid value for the first content item is based on the profitability value.

6. The method of claim 4, wherein the object data specifies a second object and a second number of occurrences of the second object in images that were provided, over the specified period of time, to the one or more computing devices identified by the identifier, and wherein the method further comprises:
selecting, based on the object data, a second content item that corresponds to the second object;
determining a second bid value for the second content item based on the second number of occurrences of the second object to which the second content item corresponds; and
providing the second bid value for the second content item to the content item selection process.

7. (canceled)

8. The method of claim 1, wherein each image is associated with a timestamp that corresponds to a time that the image was provided to the computing device, and wherein each timestamp of each image in the set of images is within a threshold period of time from a current time.

9. The method of claim 1, wherein detecting objects visually depicted in the image comprises identifying a most prominent object depicted in the image based on a size and location within the image of the objects.

10. A system comprising:
one or more data processing apparatus; and
a data store storing instructions that, when executed by the one or more data processing apparatus, cause the one or more data processing apparatus to perform operations comprising:
receiving, from a computing device associated with a given user, image identifiers specifying images that were presented at the computing device;
detecting objects depicted in the images that were presented at the computing device, including performing one or more object recognition processes on the images;
storing, in an object history data store and based on the detecting, object data including a number of times that a particular object was visually depicted in the images that were presented at the computing device in association with an identifier of the user;
receiving a request for a content item from a computing device, the request including the identifier of the user;
accessing, in the object history data store, the object data specifying the number of times that the particular object was visually depicted in the images that were presented at the computing device;
determining, based on the object data associated with the identifier, that the particular object was visually depicted in multiple different images at multiple different webpages that were accessed by the computing device over a specified period of time;
determining that the number of times that the particular object was visually depicted in the multiple different images at the multiple different webpages meets a threshold number of times;
selecting, based on the determination that the number of times meets the threshold, a first content item that visually depicts the particular object or includes text identifying the particular object for distribution to the computing device, the selecting including using a mapping of objects to content items to determine that the first content item is mapped to the particular object; and
distributing, in response to the request and to the computing device, machine readable instructions that initiate presentation of the first content item with a third party webpage.

11-12. (canceled)

13. The system of claim 10, wherein the operations further comprise:
determining a first bid value for the first content item based on the number of occurrences of the particular object to which the first content item corresponds;
providing the first bid value for the first content item to a content item selection process that, based at least in part on bid values, selects one or more content items to be provided in response to the request; and
receiving an indication that the first content item is selected by the content item selection process.

14. The system of claim 13, wherein the operations further comprise:
identifying, for the particular object, a profitability value that indicates a measure of profitability of the particular object, and wherein the first bid value for the first content item is based on the profitability value.

15. The system of claim 13, wherein the object data specifies a second object and a second number of occurrences of the second object in images that were provided, over the specified period of time, to the one or more computing devices identified by the identifier, and wherein the operations further comprise:
selecting, based on the object data, a second content item that corresponds to the second object;
determining a second bid value for the second content item based on the second number of occurrences of the second object to which the second content item corresponds; and
providing the second bid value for the second content item to the content item selection process.

16. (canceled)

17. The system of claim 10, wherein each image is associated with a timestamp that corresponds to a time that the image was provided to the computing device, and wherein each timestamp of each image in the set of images is within a threshold period of time from a current time.

18. The system of claim 10, wherein detecting objects visually depicted in the image comprises identifying a most prominent object depicted in the image based on a size and location within the image of the objects.

19. A computer readable medium storing instructions that, when executed by one or more data processing apparatus, cause the one or more data processing apparatus to perform operations comprising:
receiving, from a computing device associated with a given user and by the one or more data processing apparatus, image identifiers specifying images that were presented at the computing device;
detecting, by the one or more data processing apparatus, objects depicted in the images that were presented at the computing device, including performing one or more object recognition processes on the images;
storing, in an object history data store by the one or more data processing apparatus and based on the detecting, object data including a number of times that a particular object was visually depicted in the images that were presented at the computing device in association with an identifier of the user;
receiving, by the one or more data processing apparatus, a request for a content item from the computing device, the request including the identifier of the user;
accessing, by the one or more data processing apparatus and in the object history data store, the object data specifying the number of times that the particular object was visually depicted in the images that were presented at the computing device;
determining, based on the object data associated with the identifier and by the one or more data processing apparatus, that the particular object was visually depicted in multiple different images at multiple different webpages that were accessed by the computing device over a specified period of time;
determining, by the one or more data processing apparatus, that the number of times that the particular object was visually depicted in the multiple different images at the multiple different webpages meets a threshold number of times;
selecting, based on the determination that the number of times meets the threshold, a first content item that visually depicts the particular object or includes text identifying the particular object for distribution to the computing device, the selecting including using a mapping of objects to content items to determine that the first content item is mapped to the particular object; and
distributing, in response to the request and to the computing device, machine readable instructions that initiate presentation of the first content item with a third party webpage.

20. (canceled)
